(19) United States
(12) Patent Application Publication
(10) Pub. No.: US 2002/0156750 A1
(43) Pub. Date: Oct. 24, 2002

(54) Business system for supplying heat and cold heat

(76) Inventors: Kuniaki Kawamura, Tokyo (JP); Shinjiro Akaboshi, Tokyo (JP)

Correspondence Address: CROWELL & MORING LLP, INTELLECTUAL PROPERTY GROUP, P.O. BOX 14300, WASHINGTON, DC, 20044-4300, US

(21) Appl. No.: 09/840,451

(22) Filed: Apr. 24, 2001

(51) Int. Cl. G06F 17/00

(52) U.S. Cl. 705/412

(57) ABSTRACT

The present invention provides a business system for supplying heat/cold heat, in which a group of heat/cold heat cycle units which are constructed as portable, integral ones having high reliability and maintainability and equipped with efficient evaporative condensers are provided, those units are put to lease to users, the units are put under good management through a network including the Internet, optimal operation thereof are enabled, heat/cold heat energy is generated effectively for the users, and business of supplying heat/cold heat energy is made possible by including the usage charge of the heat/cold heat energy in the rental of the heat/cold heat cycle units, user's factories A, B, C, . . . which receive the supply of the heat/cold heat energy being connected to the Internet 11 by the medium of browsers 15, 15, . . . , the factories A, B, C, . . . renting heat/cold heat cycle units 10a, 10b, 10c, a unit monitoring depot 16 for remote-monitoring the operation conditions, etc., and WWW servers 12, 13 which constitute a unit monitoring depot 16 for remote-monitoring the operating conditions of the heat/cold heat cycle units leased to the users and a unit maintenance depot 17 for controlling the leased heat/cold heat cycle units respectively being provided.

### BACKGROUND OF THE INVENTION

1. Field of the Invention

The present invention relates to a business system for supplying heat/cold heat, in which heat source equipment comprising a group of heat/cold heat cycle units, each unit being integral and portable one with high reliability and high maintainability equipped with an evaporative condenser of high efficiency is prepared, the group of the heat/cold heat cycle units is put under good management through a network including the Internet, the heat/cold heat cycle units are put out to lease to a user to enable the efficient generation of heat/cold heat for the user by the optimal operation of each unit for the needed heat/cold heat load of the user, and a business is possible for supplying the heat/cold heat in return for a rental fee in which the usage charge for the amount of the heat/cold heat used by the user is included.

2. Description of the Related Art

Since the oil crisis, energy saving has been a point at issue, the reduction of carbon dioxide emission has become a problem for preventing global warming, and the improvement of the efficiency of energy used by users has been needed. Also, it is required to provide a service as a package for solving the problems the users met at the implementation of improvement of energy efficiency.

The said service is required to contribute to the improvement of constitutional tendencies of installations in use to energy wasting by changing from “facility's individual energy saving” to “installation's total energy saving”.

The electric power consumed by an air conditioning system consisted of a refrigerating cycle equipment such as compressor and heat exchanger, a heat source equipment including a fan, air filter, and automatic control equipment, and an air conditioning equipment which uses heat/cold heat energy, makes up a top class of electric power consumption. The improvement of energy saving property of the air conditioning systems is not only the needs of the market place but also the needs of the society.

It has been necessary to purchase the facility for air conditioning having the capacity which can meet the daily and monthly peak cooling load in the summer and peak heating load in the winter.

A heat/cold heat supply system or operation system thereof which can adapt to a low load operation, accordingly to a low efficiency operation in the spring, autumn, and in the nighttime, is required.

There has been a system which eliminates the necessity of coincidence of the generation of heat/cold heat and the consumption thereof by providing a heat storage tank such as ice heat storing means, etc. between the supply side and consumer side of heat/cold heat, the heat storage tank having a buffer function to cut off the time relation between the heat source equipment and air conditioning equipment. However, there remain problems that the installation of the heat storage tank demands high cost and large space.

A heretofore generally used air conditioning system as mentioned above is of a central air conditioning type with evaporative condensers provided separately with the refrigerant liquid sent to each condenser located at each part by a liquid pump.

However, in the case of the above mentioned central air conditioning system, a machine room is necessary to be prepared separately. Further, as the air conditioning system can not immediately be changed to adapt to the change of layout in the office or factory, the problem of loss of comfort and efficiency, that is, the problem of flexibility of the system arises.

There is also a problem that, in case of non-uniformity of air conditioning in a building resulting in too hot in some places and too cold in other places, a fundamental improvement or change is difficult because of the central air conditioning system.

Further, in the conventional air conditioning system, a heat source equipment is provided with a separate evaporative condensers, so it is difficult for the system to have high energy-efficiency, reliability, maintainability, and of course transportability compared with a package type which has a refrigerating cycle equipment such as compressor and heat exchanger, etc., and fan, air filter, and automatic control equipment, etc. housed in a casing and manufactured in a factory under quality control.

Also, there is a problem that the users refrain from the renewal of the system until the depreciation thereof is finished even if the equipment operates with improperly low efficiency, because the depreciation is recognized as cost during the depreciation period of the assets in addition to the that reason the cost of the equipment and also of the machine room for housing the equipment is required for the renewal thereof, which makes users to hesitate the renewal of the air conditioning system for keeping up with the change of environment in order to attain energy-saving and better efficiency

### SUMMARY OF THE INVENTION

The object of the present invention is to provide a business system for supplying heat/cold heat, in which a group of heat/cold heat cycle units which are integral and portable with high reliability and high maintainability having a evaporative condenser of high efficiency is prepared, the group of the units is put under good management through a network including the Internet, the heat/cold heat cycle units are put out to lease to a user to enable the efficient generation of heat/cold heat for the user by the optimal operation of each unit for the needed heat/cold heat load of the user, and a business is possible for supplying the heat/cold heat in return for a rental fee in which the usage charge for the amount of the heat/cold heat used by the user is included.

That is, the business system according to the present invention is characterized in keeping watch on the amount of the heat(including heat and cold heat) used by a user through a network such as the Internet, Intra-net, etc. or on dialup or dedicated lines or on a radio channel(hereafter referred to as a network), and in calling upon the user to install additional heat/cold heat unit (hereafter referred to as unit) or to reduce the number of units or to replace the unit with a different class one in accordance with the variation of the heat/cold heat load.

The invention cited above is effective in the business which enables the user to use heat/cold heat energy effectively by leasing out the most proper unit for the user's demand of heat/cold heat through using the Internet, the Intra-net which is an internet inside a company, dialup or dedicated lines, or radio channel.

Thus, the heat/cold heat load that is required by the user and the amount of the heat/cold heat used by the user is monitored through the Internet, and recommendation of upgrading or downgrading the capacity of the unit is done for the user to be supplied with the needed energy efficiently by the unit operated optimally resulting in energy saving.

The present invention contributes to the improvement of the energy-wasting tendency of existing installations by changing to “energy saving of total installations” from “energy saving of individual equipment”, and the improvement of efficiency can be implemented without user's consideration for the depreciation of assets

As the heat/cold heat unit is constructed as a portable package as described later, the need for preparing the machine room and equipment for installation, etc. in case of adding or reducing the number of the heat/cold heat units leased out to the user is eliminated and also the change of layout can be flexibly dealt with.

Further, it is suitable in the present invention that the load of the unit leased out to the user is monitored through the network, and the user is called upon to install additional unit or replace the unit by larger one when the continuous or intermittent load of the unit during a certain period exceeds the prescribed upper limit in its cumulative level.

The invention cited above makes efficient supply of energy possible by keeping the operation of the unit near the rated operation condition, in which particularly load conditions of the operation conditions of the heat/cold heat unit leased to the user are obtained in an at-a-glance chart or in a graph display through remote monitoring, and when the continuous or intermittent load of the unit during a certain period exceeds the prescribed upper limit in its cumulative level, the user is called upon to install additional unit or replace the unit by larger one.

Still further, it is suitable in the present invention that, when the continuous or intermittent load of the unit during a certain period fall short of the prescribed lower limit in its cumulative level, the user is called upon to reduce the number of the units in use or to replace the unit by smaller one.

In the invention cited above, in the case the load rate falls below the prescribed lower limit in the cumulative level of continuous or intermittent load, the user is recommended to reduce the number of the units in use or to replace the unit with smaller one.

Yet further, it is suitable in the present invention that a WWW server is provided at each of a monitoring depot for monitoring the load and the amount of heat/cold heat used, and a maintenance depot for executing management tasks such as addition or reduction of the number of units or replacement of the unit with a larger or smaller one and maintenance of the units, and these data are shared through the network.

Also, the present invention is suitable to be constituted so that a monitoring depot where operation conditions and load conditions of the heat/cold heat cycle unit leased to the user are remote-controlled and concerned information is collected, and a maintenance depot where the obtained information concerning the operating conditions and load conditions are analyzed to determine the number of units for enabling optimal operation and the management for addition or reduction of the number of units or replacement of the unit by a larger or smaller one and the maintenance of those units are executed, are connected to a WWW server for the data at both depots to be shared in the WWW server. Particularly, it is suitable that the a monitoring depot for monitoring the load and the amount of heat/cold heat used and a maintenance depot for executing maintenance tasks such as addition or reduction of the number of units or replacement of the unit by a larger or smaller one are coalesced into a depot, and the data are shared by the common WWW server.

Also, it is suitable that the payment of the user includes the usage charge for the heat/cold heat corresponding to fluctuating loads, particularly that the payment is the rental for the unit, the rental including the usage charge for the heat/cold heat corresponding to fluctuating loads.

Further, it is suitable that the payment of the user is paid as rental for the unit leased to the user and the rental includes the usage charge for the heat/cold heat used by the user through the unit leased to the user.

It is also suitable that the payment obtained from the user includes the management fee for the maintenance, etc. of the unit and the presence or absence of irregularity is monitored by an irregularity detection signal including the load conditions of the unit installed at a user's site obtained through the network, and maintenance of the unit is recommended based on the presence or absence of irregularity.

Further, in the present invention, functions of the monitoring and maintenance depots which are connected to a WWW server of the Internet for maintaining and managing the heat/cold heat cycle unit leased to the user are determined. At the monitoring depot load conditions and the presence or absence of irregularity is detected by constant remote monitoring of operating conditions, and at the maintenance depot necessary items for maintenance are determined according to the daily report, historical data of operation, historical data of alarm, etc. prepared based on the monitoring data sent from the monitoring depot. The user is instructed to carry out the maintenance items determined as cited above to constantly keep the unit at optimal operating conditions.

Further, it is suitable that the irregularity detection signal includes pictorial data showing the operating conditions of the unit, and also suitable that the maintenance includes the maintenance and repairs together with the replacement of unit.

Also, it is suitable that the unit is a portable evaporative condenser unit, particularly that the heat/cold heat cycle unit used in the present invention is composed as a portable, package type heat source equipment using an evaporative condenser which is superior in condensing efficiency, whereby increasing of the number of units or replacement by a larger or smaller unit is possible. Thus, by securing flexibility, energy saving is effected.

Further, it is suitable that the portable unit with an evaporative condenser is a self-completed type unit which allows heat/cold heat cycle to be performed in the unit except the taking-out of heat/cold heat to a secondary side load. Thus, in the present invention, as the heat/cold heat cycle unit is constructed as a portable, package type unit which is a self-completed one other than the taking-out of the heat/cold heat to the secondary side load, the harm to human body due to the leakage of refrigerant, etc. is suppressed to a minimum, and flexible adaptation to loads is possible.

### BRIEF DESCRIPTION OF THE DRAWINGS

FIG. 1 is a schematic block diagram showing a business system for supplying heat and cold heat according to the present invention.

FIG. 2 is a graph to explain the cumulative level used for deciding the additional installation or change for larger class of the unit when the load of the heat/cold heat cycle unit shown in FIG. 1 is a fluctuating, continuous or intermittent load.

FIG. 3 is a schematic configuration showing a package type heat source equipment having an evaporative condenser used as the heat/cold heat cycle unit in FIG. 1.

### DETAILED DESCRIPTION OF THE PREFERRED EMBODIMENTS

A preferred embodiment of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

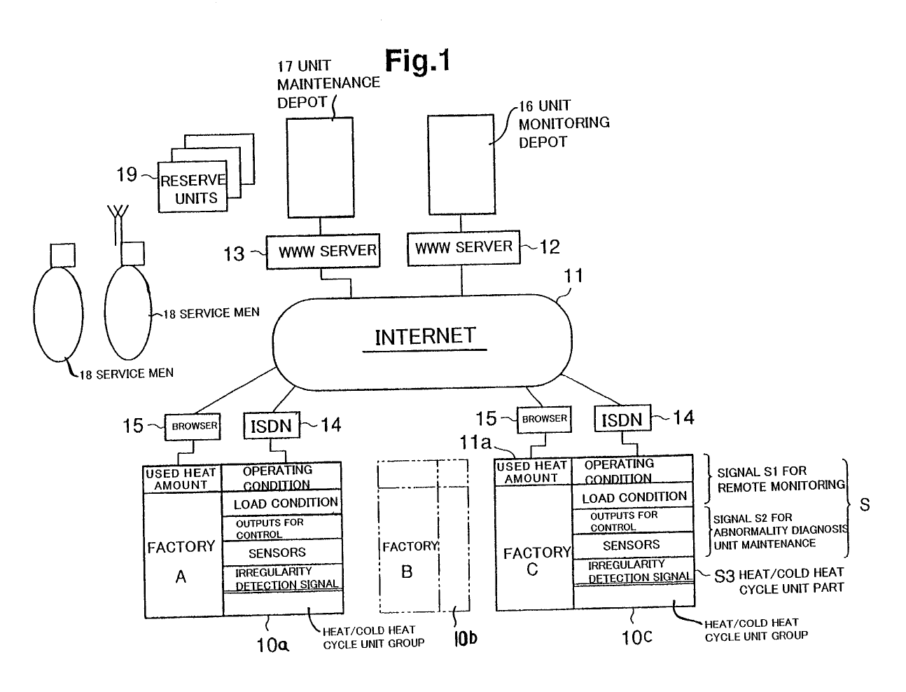

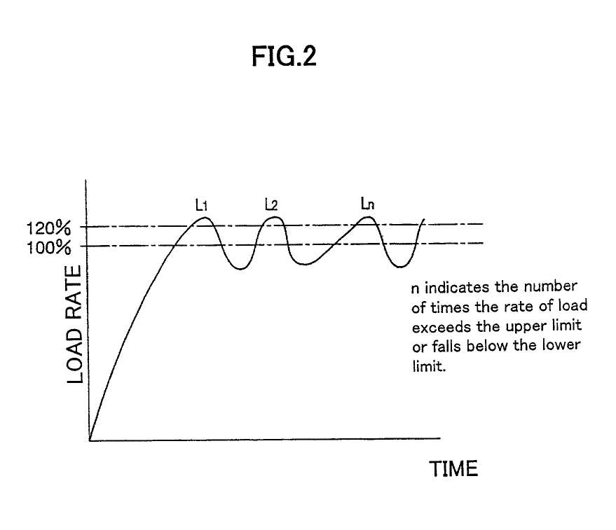

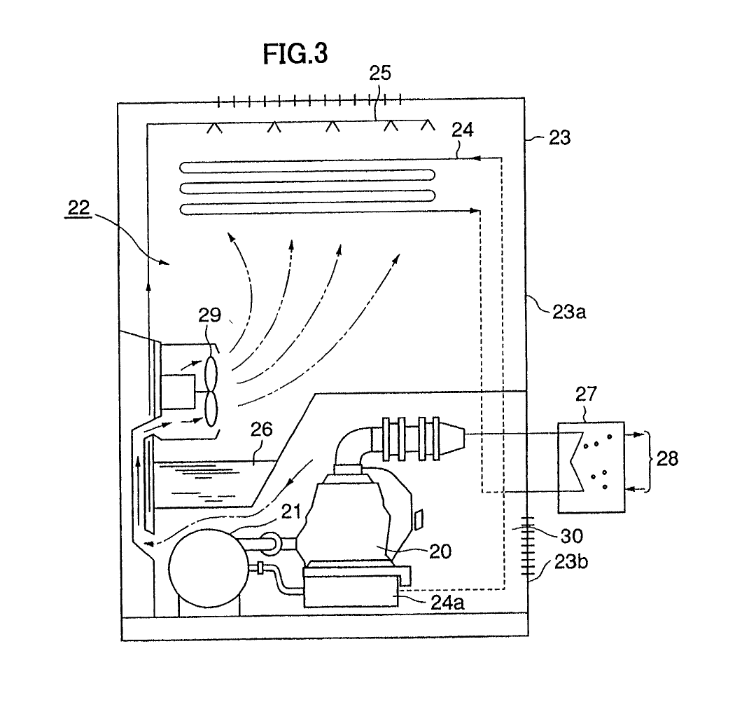

FIG. 1 is a schematic block diagram showing a business system for supplying heat and cold heat according to the present invention, and FIG. 2 is a graph to explain the cumulative level used for deciding the additional installation or change for larger class of the unit when the load of the heat/cold heat cycle unit shown in FIG. 1 is a fluctuating, continuous or intermittent load. FIG. 3 is a schematic configuration showing a package type heat source equipment having an evaporative condenser used as the heat/cold heat cycle unit in FIG. 1.

As shown in FIG. 1, factories A, B, C, . . . which receive the supply of heat/cold heat energy are linked by way of browsers 15, 15, . . . to the Internet 11. The factory A, for example, rents a group of heat/cold heat cycle unit 10a on lease to get proper amount of heat/cold heat corresponding to the load of the factory, the factory B rents a group of heat/cold heat cycle unit 10b on lease, and the factory C rents a group of heat/cold heat cycle unit 10c on lease.

To the Internet 11 are provided WWW server 12 and 13, each, respectively, forming a unit monitoring depot 16 which keeps the constant watch on changes of load and operating conditions responding to the changes of load of the heat/cold heat cycle unit or units leased to the user, and a unit maintenance depot 17 which supervises energy-saving operation through calling upon the user to grade-up or grade-down the capacity of the unit or units or to replace the unit or units by one or ones of different capacity based on the result of the monitoring for the sake of keeping optimum operating conditions in accordance with the changes of load for attaining efficient supply of heat/cold heat. Close connections can be made whenever necessary between the unit maintenance depot 17 and a plurality of reserve units 19 with service men 18 being on standby.

Data signals S such as signal S1 for remote monitoring regarding the conditions of operation and changes of load, signal S2 for irregularity diagnosis/unit maintenance, signal S3 for irregularity detection, and the like are sent from user's factories A, B, C, etc. over ISDN circuits 14 constantly to the WWW server 12 which forms the unit monitoring depot 16 provided on the Internet 11.

An at-a-glance chart or graph indicating operating and load conditions is produced from the remote monitoring signal S1 and whether cumulative level of fluctuating heat/cold heat load is above the prescribed upper limit level or below the prescribed lower limit level, as illustrated in FIG. 2, is determined at the unit monitoring depot 16 of the WWW server 12.

The result of judgement is sent over the data communication circuit to the unit maintenance depot 17 via the WWW server 13, and the maintenance depot 17 reports the amount 11a of heat used based on the result to the user side by way of the Internet 11 and browsers 15.

When the cumulative level exceeds the prescribed upper limit level or falls below the prescribed lower limit level, the user is called upon to install additional unit or reduce the number of units now in use, or to upgrade or downgrade the capacity of the unit or some of the units now in use. In this way, the user is supervised to be able to always achieve optimal energy-saving operation in accordance with fluctuating load. The charge for the usage of the heat/cold heat is received from the user together with the rental of the unit.

In FIG. 2 is shown a case where the cumulative level is used for determining whether the number of units is to be increased or decreased or whether the unit or some of the units are to be replaced by larger one or ones in the case the load of heat/cold heat is a fluctuating, continuous or intermittent one.

When the average of peak values Li of the fluctuating load as shown in FIG. 2 is larger than the prescribed upper limit, that is, when

(L₁+L₂+ . . . +Lₙ)/n>prescribed upper limit(load rate of 120%, for example),

additional installation of unit or units or replacement of the unit or units by larger one or ones is recommended to the user.

If the average of peak values Li of the fluctuating load is smaller than the prescribed lower limit, that is, when

(L₁+L₂+ . . . +Lₙ)/n<prescribed upper limit(load rate of 80%, for example),

reduction of the number of units or replacement of the unit or units by smaller one or ones is recommended to the user.

The signal S2 for irregularity diagnosis/unit maintenance comprises a variety of outputs for control, a variety of sensor output signals, and the like and produces constant monitoring data.

The steady state of operation is defined based on the analysis of the collected monitoring data, through which the maintenance management is made possible. When the state of operation deviates from the steady-state, it is reported without delay from the unit monitoring depot 16 to the unit maintenance depot 17 and contact is established with the user by way of the Internet 11 and browser 15, and at the same tome the service man 18 is dispatched to execute the maintenance of the equipment. When the irregularity detection signal appears, countermeasures are determined based on the historic record of countermeasures against irregularity at the unit monitoring depot 16 and countermeasures are taken speedily at the unit maintenance depot 17.

It is suitable to superimpose pictorial data signals on the signal for monitoring operating conditions to improve the accuracy of monitoring. It is also suitable that the WWW server 12 is coalesced into the WWW server 13 so that the unit monitoring depot 16 and unit maintenance depot 17 share the data to enhance efficiency.

As each heat/cold heat cycle unit of the group of the units 10 is composed of a package type, portable heat source equipment accommodating an evaporative condenser which is superior in condensing efficiency, the addition or reduction of the number of units and replacement by a larger or smaller unit are possible to meet the variations of load according to the changes of atmospheric temperature and the variations of load according to the change of layout and specifications of units.

The package type heat source equipment using the evaporative condenser is, as shown in FIG. 3, a portable, integrated package 23 composed of a lower chamber 23b accommodating a compressor 20, an oil separator 21, a precooler 24a, and constituent members including refrigerant piping and the like, and an upper chamber 23a accommodating an evaporative condenser 22 including a heat transfer coil 24, cooling water spray nozzles 25, a fan 29, a cooling water tank 26, and a cooling water circulation pump and piping (not shown). The equipment is manufactured under factory's specified quality control. So it is stable in quality in addition to that it is easy to handle and superior in mountability and has flexibility to adapt to the changes of layout. Further, as it is constructed to be able to be installed in the outdoors, it is not necessary to prepare a machine room, and the user side can easily accommodate to the addition of heat/cold heat cycle unit or the change of class of the unit.

Further, as shown in FIG. 3, a heat exchanger 27 connecting to a secondary side load 28 of air conditioning is provided close to the compressor, and heat/cold heat cycle is performed in the package 23 except the taking-out of heat/cold heat to the secondary side load. Accordingly, the harm to human body due to the leakage of refrigerant, etc. is suppressed to a minimum.

The user pays the rental containing the usage charge for user's heat/cold heat use corresponding to the fluctuating loads of the unit together with the maintenance fee. The user is relieved from any tasks including the determination of rational capacity of equipment for energy generation and maintenance and control of the equipment as an equivalent for paying the fee.

The present invention is constituted so that a group of heat/cold heat cycle units which are constructed as portable, integral ones having high reliability and maintainability, is leased to a user in the state they can effectively accommodate to fluctuating loads and heat/cold heat energy is supplied for adequate usage charge. Therefore, the user can use highly flexible and efficient heat/cold heat energy produced by keeping optimal operating of the group of the units corresponding to the fluctuation of loads, which results in energy saving.

As the monitoring of operating conditions and acquisition of data for irregularity diagnosis and equipment maintenance of the heat/cold heat units leased to a plurality of users are carried out through the Internet, efficient maintenance is possible by analyzing those data.

What is claimed

1. A business system for supplying heat/cold heat characterized in keeping watch on the amount of the heat(including heat and cold heat) used by a user through a network such as the Internet, Intra-net, etc. or on dialup or dedicated lines or on a radio channel(hereafter referred to as a network), and calling upon the user to install additional heat/cold heat unit(hereafter referred to as unit) or reduce the number of units or replace by a different class one in accordance with the variation of the heat/cold heat load.

2. A business system for supplying heat/cold heat according to clam 1, characterized in that the load of the unit leased to the user is monitored through the network, and the user is called upon to install additional unit or replace the unit by larger one when the cumulative level of continuous or intermittent load of the unit during a certain period exceeds the prescribed upper limit.

3. A business system for supplying heat/cold heat according to claim 1, characterized in that when the cumulative level of continuous or intermittent load of the unit during a certain period falls below the prescribed lower limit, the user is called upon to reduce the number of the units in use or replace the unit by smaller one.

4. A business system for supplying heat/cold heat according to claim 1, characterized in that a WWW server is provided at each of a monitoring depot for monitoring the load and the amount of heat/cold heat used and a maintenance depot for executing maintenance tasks such as addition or reduction of the number of units or replacement of the unit by larger or smaller one, and these data are shared through the network.

5. A business system for supplying heat/cold heat according to claim 1, characterized in that a monitoring depot for monitoring the load and the amount of heat/cold heat used and a maintenance depot for executing maintenance tasks such as addition or reduction of the number of units or replacement of the unit by larger or smaller one and maintenance of the unit, are coalesced into a depot, and the data are shared by a common WWW server.

6. A business system for supplying heat/cold heat according to claim 1, characterized in that the payment of the user includes fluctuating usage charge (charge for fluctuating heat/cold heat corresponding to fluctuating loads).

7. A business system for supplying heat/cold heat according to claim 1, characterized in that the payment of the user is the rental for the unit, the rental including the fluctuating usage charge which fluctuates according to the fluctuation of the load of the unit (charge for fluctuating heat/cold heat corresponding to fluctuating loads).

8. A business system for supplying heat/cold heat according to claim 1, characterized in that the payment of the user includes the management fee for the maintenance, etc. of the unit and the presence or absence of irregularity is monitored by an irregularity detection signal obtained through the network inclusive of the load conditions of the unit installed at a user's site, and maintenance of the unit is recommended based on the presence or absence of irregularity.

9. A business system for supplying heat/cold heat according to claim 8, characterized in that the irregularity detection signal includes pictorial data showing the operating conditions of the unit.

10. A business system for supplying heat/cold heat according to claim 8, characterized in that the maintenance includes the maintenance and repairs together with the replacement of unit.

11. A business system for supplying heat/cold heat according to claim 1, characterized in that the unit is a portable heat source unit with an evaporative condenser.

12. A business system for supplying heat/cold heat according to claim 1, characterized in that the portable heat source unit with an evaporative condenser is a self-completed type unit which allows heat/cold heat cycle to be performed in the unit except the taking-out of heat/cold heat to a secondary side load.
